(19) United States
(12) Patent Application Publication
(10) Pub. No.: US 2025/0317797 A1
(43) Pub. Date: Oct. 9, 2025

(54) METHODS AND APPARATUSES FOR A PDCP SDU RECEPTION HANDLING OPERATION

(71) Applicant: LENOVO (BEIJING) LIMITED, Beijing (CN)

(72) Inventors: Xiaoying Xu, Shanghai (CN); Mingzeng Dai, Shanghai (CN); Lianhai Wu, Beijing (CN)

(21) Appl. No.: 18/865,080

(22) PCT Filed: May 13, 2022
(86) PCT No.: PCT/CN2022/092841

§ 371 Date: Nov. 12, 2024

(51) Int. Cl. H04W 28/06; H04L 1/1607; H04W 8/22

(52) U.S. Cl. CPC H04W 28/06; H04L 1/1642; H04W 8/22

(57) ABSTRACT

Embodiments of the subject application relate to methods and apparatuses for a packet data convergence protocol (PDCP) service data unit (SDU) reception handling operation. According to an embodiment of the subject application, a user equipment (UE) includes a processor and a transceiver coupled to the processor; and the processor is configured to: receive a configuration for enabling an update function of a delivery state variable associated with a first packet data convergence protocol (PDCP) service data unit (SDU) not delivered by a PDCP entity of a data radio bearer (DRB) to an upper layer of the UE via the transceiver from a network; and enable the update function of the delivery state variable for the PDCP entity of the DRB based on the configuration.

### TECHNICAL FIELD

Embodiments of the subject application generally relate to wireless communication technology, in particular to methods and apparatuses for a packet data convergence protocol (PDCP) service data unit (SDU) reception handling operation.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, application and traffic awareness in radio access network (RAN) is one of key feature to improve user experience of XR services. Currently, details regarding a PDCP SDU reception handling operation have not been discussed yet.

### SUMMARY

Some embodiments of the subject application also provide a user equipment (UE). The UE includes a processor and a transceiver coupled to the processor; and the processor is configured to: receive a configuration for enabling an update function of a delivery state variable associated with a first packet data convergence protocol (PDCP) service data unit (SDU) not delivered by a PDCP entity of a data radio bearer (DRB) to an upper layer of the UE via the transceiver from a network; and enable the update function of the delivery state variable for the PDCP entity of the DRB based on the configuration.

In some embodiments, the processor of the UE is configured to: receive an update indication for the delivery state variable via the transceiver from the network; and update the delivery state variable to a target count value associated with a second PDCP SDU according to the update indication.

In some embodiments, the update indication is included in a header associated with the second PDCP SDU, and wherein the processor of the UE is configured to determine a count value of the second PDCP SDU as the target count value.

In some embodiments, the processor of the UE is configured to: after receiving the update indication, deliver all of one or more stored PDCP SDUs with count values less than or equal to the target count value by the PDCP entity of the DRB to the upper layer of the UE before updating the delivery state variable.

In some embodiments, the first PDCP SDU belongs to a first frame, and wherein the update indication indicates at least one of: whether the second PDCP SDU belongs to a second frame; or whether the second PDCP SDU is a start PDCP SDU of the second frame.

In some embodiments, in response to the second PDCP SDU being not the start PDCP SDU of the second frame, the processor of the UE is configured to: determine whether a reordering timer of the PDCP entity of the DRB is running; and in response to determining that the reordering timer is running: restart the reordering timer; or stop the reordering timer.

In some embodiments, the update indication is included in a PDCP control protocol data unit (PDU) or a medium access control (MAC) sub-PDU.

In some embodiments, the processor of the UE is configured to consider a reordering timer of the PDCP entity of the DRB as expired if the update indication is received, in a case that the reordering timer is running.

In some embodiments, the processor of the UE is configured to determine the target count value based on a PDCP sequence number (SN) or a PDCP count value, in response to the PDCP control PDU including the PDCP SN or the PDCP count value.

In some embodiments, the processor of the UE is configured to: determine a count value of the PDCP control PDU based on the PDCP SN; and determine the count value of the PDCP control PDU as the target count value.

In some embodiments, the PDCP control PDU includes a PDCP header including a PDU type field, and wherein the PDU type is associated with the update indication.

In some embodiments, the MAC sub-PDU includes a logical channel (LCH) identity (ID) field associated with the update indication.

In some embodiments, the first PDCP SDU belongs to a first frame, and wherein the processor of the UE is configured to: receive a third PDCP SDU via the transceiver from the network; and determine whether the third PDCP SDU is a firstly received PDCP SDU of a third frame.

In some embodiments, in response to determining that the third PDCP SDU is the firstly received PDCP SDU of the third frame, the processor of the UE is configured to deliver all of one or more stored PDCP SDUs of the first frame by the PDCP entity of the DRB to the upper layer of the UE.

In some embodiments, the processor of the UE is configured to: in response to determining that the third PDCP SDU is the firstly received PDCP SDU of the third frame and is not a start PDCP SDU of the third frame, determine whether a reordering timer of the PDCP entity of the DRB is running; and in response to determining that the reordering timer is running: restart the reordering timer; or stop the reordering timer.

In some embodiments, the processor of the UE is configured to update the delivery state variable to one plus a maximum count value of a PDCP SDU of the first frame stored by the UE.

In some embodiments, the processor of the UE is configured to deliver all of one or more stored PDCP SDUs of the third frame with one or more consecutive count values starting from the updated delivery state variable by the PDCP entity of the DRB to the upper layer of the UE.

In some embodiments, the processor of the UE is configured to: receive a fourth PDCP SDU via the transceiver from the network; determine whether the fourth PDCP SDU is a firstly received PDCP SDU of a fourth frame; and in response to determining that the fourth PDCP SDU is the firstly received PDCP SDU of the fourth frame, starting a reordering frame timer associated with the fourth frame.

In some embodiments, in response to an expiry of the reordering frame timer, the processor of the UE is configured to deliver all of one or more stored PDCP SDUs of the fourth frame by the PDCP entity of the DRB to the upper layer of the UE.

In some embodiments, the processor of the UE is configured to update the delivery state variable to one plus a maximum count value of a PDCP SDU of the fourth frame stored by the UE.

Some embodiments of the subject application also provide a network node (e.g., a base station (BS)). The network node includes a processor and a transceiver coupled to the processor; and the processor is configured to receive a capability supporting an update function of a delivery state variable associated with a packet data convergence protocol (PDCP) service data unit (SDU) received by a user equipment (UE) via the transceiver from the UE; and transmit a configuration for enabling the update function of the delivery state variable of a PDCP entity of a DRB of the UE via the transceiver to the UE.

In some embodiments, the processor of the network node is configured to transmit an update indication for the delivery state variable of the PDCP entity of the DRB of the UE via the transceiver to the UE.

In some embodiments, the processor of the network node is configured to transmit a first PDCP SDU of a first frame, and wherein the update indication indicates at least one of: whether a second PDCP SDU belongs to a second frame; or whether the second PDCP SDU is a start PDCP SDU of the second frame.

In some embodiments, the update indication indicates at least one of: the UE to consider a count value of the second PDCP SDU as a target count value of the delivery state variable; or the UE to consider a reordering timer of the PDCP entity of the DRB as expired in a case that the reordering timer is running.

In some embodiments, the update indication is included in at least one of: a header associated with the second PDCP SDU; a PDCP control protocol data unit (PDU); or a medium access control (MAC) sub-PDU.

In some embodiments, the header associated with the second PDCP SDU implicitly indicates the UE to consider a count value of the second PDCP SDU as the target count value or indicates the UE to consider a reordering timer of the PDCP entity of the DRB as expired in a case that the reordering timer is running.

In some embodiments, the PDCP control PDU includes a PDCP header including a PDU type field, and wherein the PDU type is associated with the update indication.

In some embodiments, the MAC sub-PDU includes a logical channel (LCH) identity (ID) field associated with the update indication

In some embodiments, wherein the processor of the network node is configured to transmit a configuration related to a reordering frame timer associated with a frame via the transceiver to the UE, wherein the reordering frame timer is used to control the update function of the delivery state variable of the PDCP entity of the DRB related to the frame.

Some embodiments of the subject application provide a method, which may be performed by a UE. The method includes: receiving a configuration for enabling an update function of a delivery state variable associated with a first packet data convergence protocol (PDCP) service data unit (SDU) not delivered by a PDCP entity of a data radio bearer (DRB) to an upper layer of the UE from a network; and enabling the update function of the delivery state variable for the PDCP entity of the DRB based on the configuration.

Some embodiments of the subject application provide a method, which may be performed by a network node (e.g., a BS). The method includes: receiving a capability supporting an update function of a delivery state variable associated with a packet data convergence protocol (PDCP) service data unit (SDU) received by a user equipment (UE) from the UE; and transmitting a configuration for enabling the update function of the delivery state variable of a PDCP entity of a DRB of the UE to the UE.

Some embodiments of the subject application also provide a user equipment (UE). The UE includes a processor and a transceiver coupled to the processor; and the processor is configured to: receive a configuration for enabling a non-consecutive packet data convergence protocol (PDCP) service data unit (SDU) delivery function for a PDCP entity of a data radio bearer (DRB) to an upper layer of the UE via the transceiver from a network; and enable the non-consecutive PDCP SDU delivery function for the PDCP entity of the DRB based on the configuration.

Some embodiments of the subject application also provide a network node (e.g., a base station (BS)). The network node includes a processor and a transceiver coupled to the processor; and the processor is configured to: receive a capability supporting a non-consecutive packet data convergence protocol (PDCP) service data unit (SDU) delivery function associated with a PDCP SDU received by a user equipment (UE) via the transceiver from the UE; and transmit a configuration for enabling the non-consecutive PDCP SDU delivery function for a PDCP entity of a data radio bearer (DRB) of the UE via the transceiver to the UE.

Some embodiments of the subject application provide a method, which may be performed by a UE. The method includes: receiving a configuration for enabling a non-consecutive packet data convergence protocol (PDCP) service data unit (SDU) delivery function for a PDCP entity of a data radio bearer (DRB) to an upper layer of the UE from a network; and enabling the non-consecutive PDCP SDU delivery function for the PDCP entity of the DRB based on the configuration.

Some embodiments of the subject application provide a method, which may be performed by a network node (e.g., a BS). The method includes: receiving a capability supporting a non-consecutive packet data convergence protocol (PDCP) service data unit (SDU) delivery function associated with a PDCP SDU received by a user equipment (UE) from the UE; and transmitting a configuration for enabling the non-consecutive PDCP SDU delivery function for a PDCP entity of a data radio bearer (DRB) of the UE to the UE.

Some embodiments of the subject application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the subject application.

FIG. 2 illustrates an exemplary schematic diagram of a PDCP reordering management scheme in accordance with some embodiments of the subject application.

FIG. 3 illustrates an exemplary schematic diagram of a PDCP SN gap between frames in accordance with some embodiments of the subject application.

FIG. 4 illustrates an exemplary schematic diagram of several PDCP SN gaps in a frame in accordance with some embodiments of the subject application.

FIGS. 5 and 6 illustrate exemplary flowcharts regarding an update function of a delivery state variable in accordance with some embodiments of the subject application.

FIGS. 7 and 8 illustrate exemplary schematic diagrams for updating a delivery state variable in accordance with some embodiments of the subject application.

FIGS. 9-11B illustrate exemplary PDCP control PDU and MAC CE including an updating indication for a delivery state variable in accordance with some embodiments of the subject application.

FIGS. 12 and 13 illustrate exemplary schematic diagrams for updating a delivery state variable in accordance with some embodiments of the subject application.

FIGS. 14 and 15 illustrate exemplary schematic diagrams for a reordering frame timer in accordance with some embodiments of the subject application.

FIGS. 16 and 17 illustrate exemplary block diagrams of an apparatus for a PDCP layer reception handling operation in accordance with some embodiments of the subject application.

### DETAILED DESCRIPTION

The detailed description of the appended drawings is intended as a description of preferred embodiments of the subject application and is not intended to represent the only form in which the subject application may be practiced. It should be understood that the same or equivalent functions may be accomplished by different embodiments that are intended to be encompassed within the spirit and scope of the subject application.

Reference will now be made in detail to some embodiments of the subject application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the subject application are also applicable to similar technical problems; and moreover, the terminologies recited in the subject application may change, which should not affect the principle of the subject application.

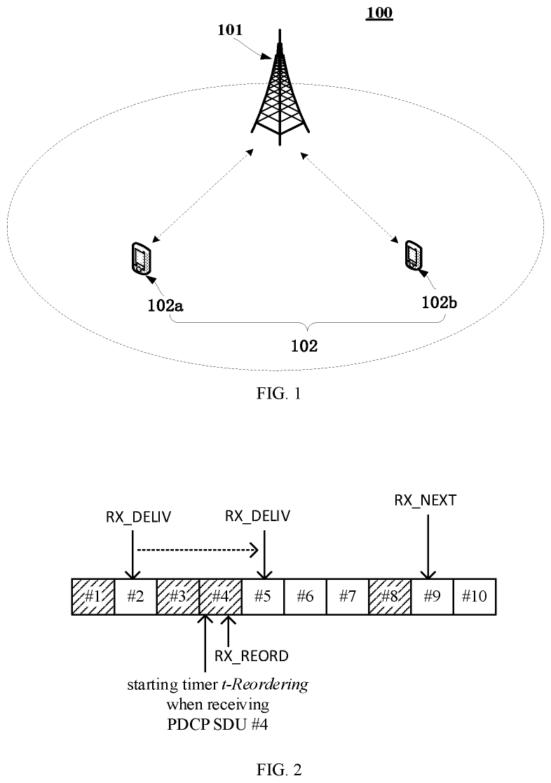

FIG. 1 illustrates a schematic diagram of a wireless communication system in accordance with some embodiments of the subject application.

As shown in FIG. 1, the wireless communication system 100 includes at least one base station (BS) 101 and at least one UE 102. In particular, the wireless communication system 100 includes one BS 101 and two UEs 102 (e.g., a UE 102a and a UE 102b) for illustrative purpose. Although a specific number of BS 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may also be referred to as a NG-RAN node, a RAN node, an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to BS 101.

According to some embodiments of the subject application, UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some other embodiments of the subject application, UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the subject application, UE(s) 102 may include wearable devices, such as smart watches, fitness bands, optical head-mounted displays, or the like. Moreover, UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both UE 102a and UE 102b in the embodiments of FIG. 1 may transmit information to BS 101 and receive control information from BS 101, for example, via LTE or NR Uu interface.

Typically, for XR services, a group of IP packets would be used to carry payloads of a PDU Set (e.g., a video frame or a video slice) and the size of a PDU set is variable, the PDU set arrives periodically. In application layer, packets in such a PDU Set should be handled as a whole, i.e., the groups of packets within the PDU Set have inherent dependency on each other.

FIG. 2 illustrates an exemplary schematic diagram of a PDCP reordering management scheme in accordance with some embodiments of the subject application. In the example of FIG. 2, the PDCP reordering management scheme may involve four parameters, including:
(1) RX_NEXT: this state variable indicates the COUNT value of the next PDCP SDU expected to be received;
(2) RX_DELIV: this state variable indicates the COUNT value of the first PDCP SDU not delivered to the upper layers, but still waited for;
(3) RX_REORD: this state variable indicates the COUNT value following the COUNT value associated with the PDCP Data PDU which triggered t-Reordering; and
(4) t-Reordering: this parameter is a PDCP reordering timer, and the duration of the timer is configured by RRC signalling.

Referring to FIG. 2, it is assumed that PDCP SDUs with count values (or sequence numbers (SNs)) #1 and #4, are received at the PDCP layer, whereas PDCP SDUs with the count value (or SN) #2, is not received at the PDCP layer. Then, RX_NEXT is #5 and RX_DELIV is #2. Since RX_DELIV<RX_NEXT, the UE may start timer t-Reordering when it receives PDCP SDU #4 earlier than PDCP SDU #3, as shown in FIG. 2. During t-Reordering is running, the PDCP SDUs with count values (or sequence numbers (SNs)) #4 and #8 are received, whereas PDCP SDUs with count values (or SNs) #2, #5, #6, #7, #9, and #10 are not received at the PDCP layer. RX_NEXT is finally updated to #9 and RX_DELIV is still #2.

When the timer t-Reordering is running, the UE waits for packet(s) with associated COUNT value of RX_DELIV and does not deliver the non-consecutive stored PDCP SDU(s) (#3, #4, #8 in FIG. 2) to upper layer(s) due to in-order delivery. When the timer t-Reordering expires, the receiving PDCP entity may deliver to the upper layer(s) all stored PDCP SDUs with associated COUNT value(s) less than RX_REORD and all stored PDCP SDU(s) with consecutively associated COUNT value(s) starting from RX_REORD. Upon the expiry of the timer t-Reordering, the UE may:
(1) Update an RX_DELIV value from PDCP SDU #2 to a COUNT value of a first packet which has not been delivered to upper layers but still waited for, i.e., PDCP SDU #5 in this example.
(2) Update an RX_NEXT value from PDCP SDU #4 to a COUNT value of a next packet expected to be received, i.e., PDCP SDU #9 in this example.
(3) Restart timer t-Reordering, because the updated RX_DELIV value is less than the updated RX_NEXT value. For example, as shown in FIG. 2, the timer t-Reordering is started when receiving PDCP SDU #4, and the timer t-Reordering is started after the expiry of the timer t-Reordering.

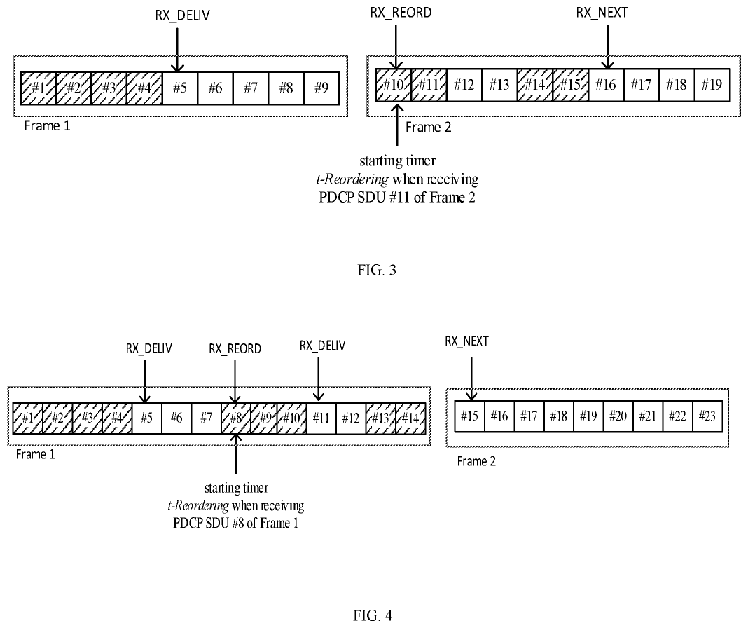

For a downlink (DL) data transmission of XR services, there may be PDCP SN gap(s) between frames or within a frame of the XR traffic, e.g., as shown in FIGS. 3, 4, 7, 8, and 12-15. Each frame of the XR traffic may include different number of PDCP SDUs according to different embodiments. For example, Frame 1 in FIG. 3 includes 9 PDCP SDUs in total, i.e., PDCP SDUs #1 to #9. Frame 2 in FIG. 3 includes 10 PDCP SDUs in total, i.e., PDCP SDUs #10 to #19. Frame 1 in FIG. 4 includes 14 PDCP SDUs in total, i.e., PDCP SDUs #1 to #14. Frame 2 in FIG. 4 includes 9 PDCP SDUs in total, i.e., PDCP SDUs #15 to #23. Although a specific number of PDCP SDUs are depicted in the embodiments of FIGS. 3, 4, 7, 8, and 12-15, it is contemplated that any number of PDCP SDUs may be included in a frame of the XR traffic without departing from the spirit and scope of the disclosure.

Moreover, Frame 1 and Frame 2 in the embodiments of FIGS. 3, 4, 7, 8, and 12-15 may be respectively labeled as Frame i and Frame i+1 or the like, the Frame i+1 is after the Frame i, without departing from the spirit and scope of the disclosure. The parameters in the embodiments of FIGS. 3, 4, 7, 8, and 12-15, e.g., RX_NEXT, RX_DELIV, RX_REORD, and/or t-Reordering have the same functions and roles as those in the embodiments of FIG. 2.

FIG. 3 illustrates an exemplary schematic diagram of a PDCP SN gap between frames in accordance with some embodiments of the subject application. In the embodiments of FIG. 3, if some consecutive PDCP PDUs of Frame 1 were not received by a UE, e.g., PDCP SDUs with count values (or SNs) #5 to #9, it must bring the PDCP SN gap after receiving PDCP SDU(s) of Frame 2 for the UE. This triggers timer t-Reordering running. For example, as shown in FIG. 3, timer t-Reordering is started when receiving PDCP SDU #11 of Frame 2. Generally, the timer length possibility is about less than or equal to the packet delay budget (PDB) length. Therefore, even if the UE has successfully received Frame 2 within the PDB, the delivery to upper layer(s) of the UE for Frame 2 is delayed due to the running t-Reordering triggered by the data loss of Frame 1.

FIG. 4 illustrates an exemplary schematic diagram of several PDCP SN gaps in a frame in accordance with some embodiments of the subject application. In the embodiments of FIG. 4, if some PDCP PDUs of Frame 1 were not received by a UE (e.g., PDCP SDUs with count values (or SNs) #5 to #7, #11, and #12), it brings two PDCP SN gaps in Frame 1 for the UE. Timer t-Reordering may be triggered two times for the UE. For example, as shown in FIG. 4, the timer t-Reordering is firstly started when receiving PDCP SDU #8 of Frame 1 while PDCP SDUs with count values (or SNs) #5 to #7 of Frame 1 are not received, and the timer t-Reordering is started after the expiry of timer t-Reordering due to PDCP SDU with count values (or SNs) #13 of frame 1 is received whereas the PDCP SDUs with count values (or SNs) #11 and #12 are not received. However, this may bring the extra deliver delay to upper layer(s) of the UE not only for Frame 1 but also for Frame 2. Once the timer t-Reordering expires, the non-consecutive PDCP SDUs will be delivered to the upper layer regardless of whether the data is valid for the upper layer.

Given the above, there is no friendly delivery scheme for a latency sensitive XR service, and there is a need to design a mechanism for delivering data to upper layer(s) for the XR traffic, to avoid the delay as much as possible. Embodiments of the present application propose mechanisms of PDCP SDU reception handling for a DL XR service, which can at least solve the above problem (e.g., how to avoid the delay during delivering data to upper layer(s) for the XR traffic as much as possible). In addition, in a case that non-consecutive PDCP SDUs are received, the data may be invalid for the application layer(s) and the unnecessary decoding handling will consume additional power. The present application also proposes mechanisms to control a delivery operation of the non-consecutive PDCP SDUs.

More specifically, in some embodiments of the subject application, a UE may update RX_DELIV to a target COUNT value according to the received delivery update indication and deliver all the stored PDCP SDUs with COUNT values less than or equal to the target COUNT value, and may further restart the timer t-Reordering if the firstly received PDCP SDU of a new frame is not a start PDCP SDU of the new frame. In some embodiments of the subject application, an indicator (e.g., 1 bit size) is included in a PDCP header associated with a PDCP SDU, and a target COUNT value is updated to the RDVD_COUNT of the PDCP SDU.

Some embodiments of the subject application design a new PDCP control PDU or MAC CE as a delivery update indication with or without an explicit target PDCP SN or COUNT value. Some embodiments of the subject application design a delivery update indication as a new frame indicator firstly received by the UE, and a target COUNT value is updated to “1+a maximum count value of a current frame”.

In some embodiments of the subject application, a UE starts timer t-Reordering-Frame upon firstly receiving a PDCP SDU of a new frame. For instance, when the timer t-Reordering-Frame expires, the UE may deliver all stored PDCP SDU(s) with the maximum count value greater than RX_DELIV and may further update the RX_DELIV to “1+a maximum count value of the PDCP SDU of the new frame which has been received”.

In the embodiments of the subject application, a frame of a XR service can be replaced by a PDU set, a data burst, or an application data unit (ADU). A PDU set may include one or more PDUs carrying the payload of one unit of information generated at the application level, which are of the same importance requirement at an application layer. In the embodiments of the subject application, IP packet(s) can be replaced with PDCP SDU(s) or PDCP PDU(s).

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

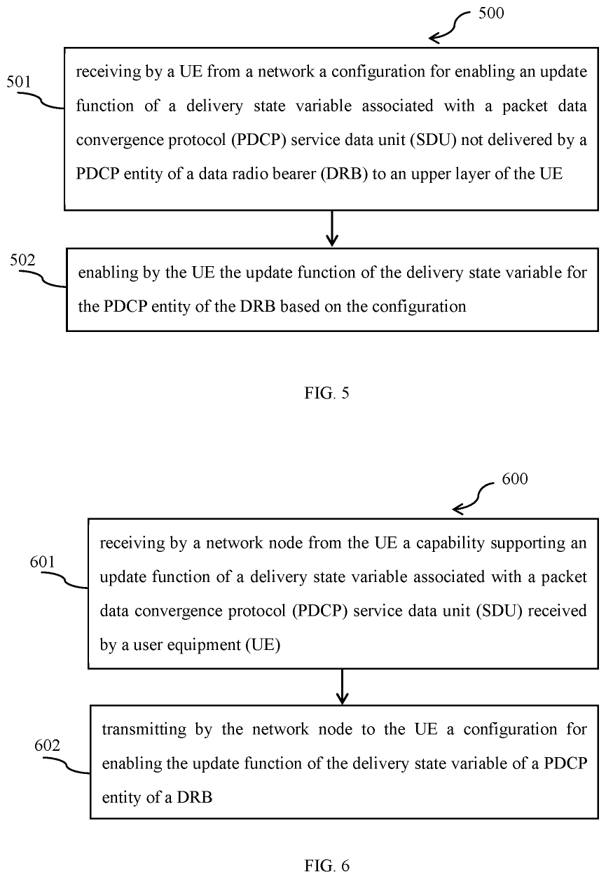

FIG. 5 illustrates an exemplary flowchart regarding an update function of a delivery state variable in accordance with some embodiments of the subject application. The exemplary method 500 in FIG. 5 may be performed by a UE, e.g., UE 102 as shown in FIG. 1. Although described with respect to a UE, it should be understood that other devices may be configured to perform a method similar to that of FIG. 5.

In the exemplary method 500 in FIG. 5, in operation 501, a UE receives a configuration for enabling an update function of a delivery state variable associated with a PDCP SDU not delivered by a PDCP entity of a DRB to an upper layer of the UE. In operation 502, the UE enables the update function of the delivery state variable (e.g., RX_DELIV) for the PDCP entity of the DRB based on the configuration.

In some embodiments, the UE receives an update indication for the delivery state variable from the network, and updates the delivery state variable (e.g., RX_DELIV) to a target count value associated with a further PDCP SDU according to the update indication.

In some embodiments, the update indication is included in a header associated with the further PDCP SDU, and the UE determines a count value of the further PDCP SDU as the target count value. In some further embodiments, the update indication is included in a header associated with the further PDCP SDU, and the UE considers a reordering timer of the PDCP entity of the DRB (e.g., timer t-Reordering) as expired in a case that the reordering timer is running.

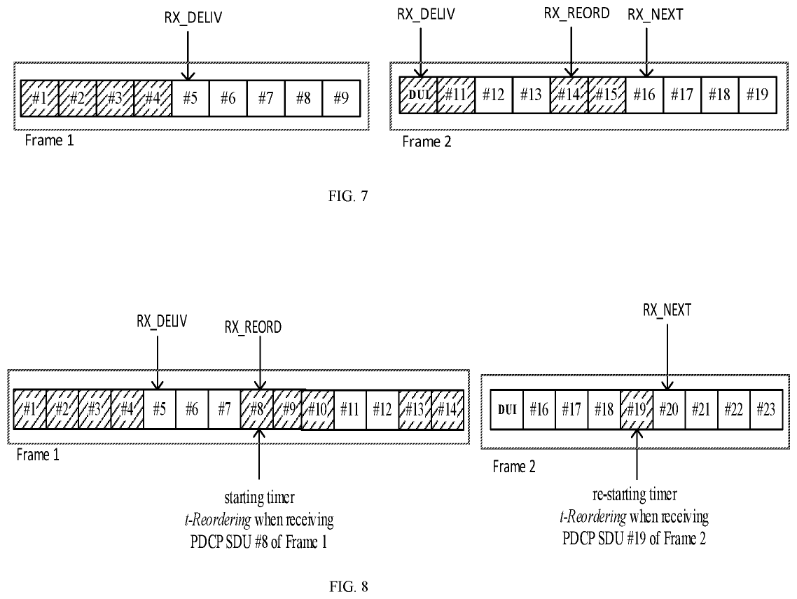

In some embodiments, after receiving the update indication, the UE delivers all of one or more stored PDCP SDUs with count values less than or equal to the target count value by the PDCP entity of the DRB to the upper layer of the UE before updating the delivery state variable (e.g., RX_DELIV). Specific examples are described in embodiments of FIGS. 7 and 8 as follows, in which an update indication for the delivery state variable (e.g., RX_DELIV) may be a delivery update indication (DUI) transmitted in a header associated with a PDCP SDU.

In some embodiments, the PDCP SDU not delivered by the PDCP entity of the DRB to the upper layer of the UE belongs to a frame (e.g., Frame 1), and the update indication indicates at least one of: whether the further PDCP SDU belongs to a further frame (e.g., Frame 2 as shown in FIG. 8); or whether the further PDCP SDU is a start PDCP SDU of the further frame (e.g., PDCP SDU #15 of Frame 2 as shown in FIG. 8). In an embodiment, in a case that the further PDCP SDU is not the start PDCP SDU of the further frame, the UE determines whether a reordering timer of the PDCP entity of the DRB is running. In response to determining that the reordering timer is running, the UE may restart the reordering timer or stop the reordering timer. A specific example is described in embodiments of FIG. 8 as follows.

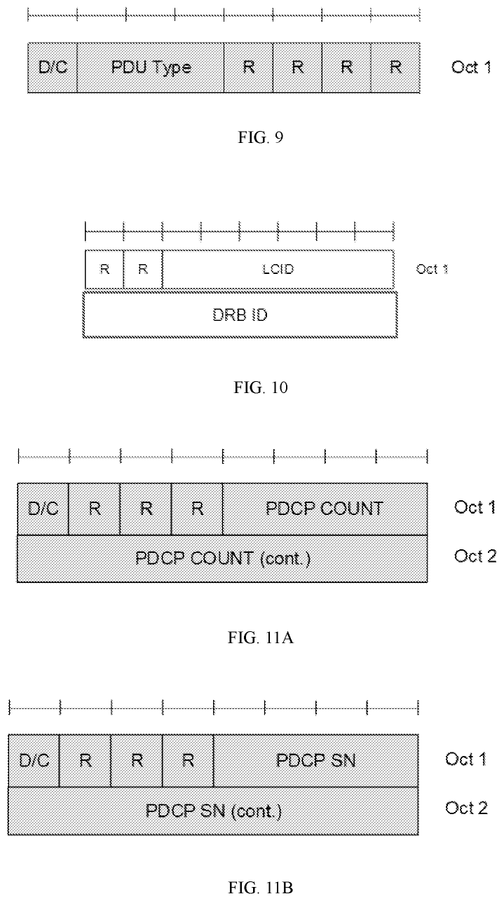

In some embodiments, the update indication is included in a PDCP control protocol data unit (PDU) or a medium access control (MAC) sub-PDU. In an embodiment, the PDCP control PDU includes a PDCP header including a PDU type field, and the PDU type is associated with the update indication. Specific examples are described in embodiments of FIGS. 9, 11A, and 11B as follows. In an embodiment, the MAC sub-PDU includes a logical channel (LCH) identity (ID) field associated with the update indication. A specific example is described in embodiments of FIG. 10 as follows.

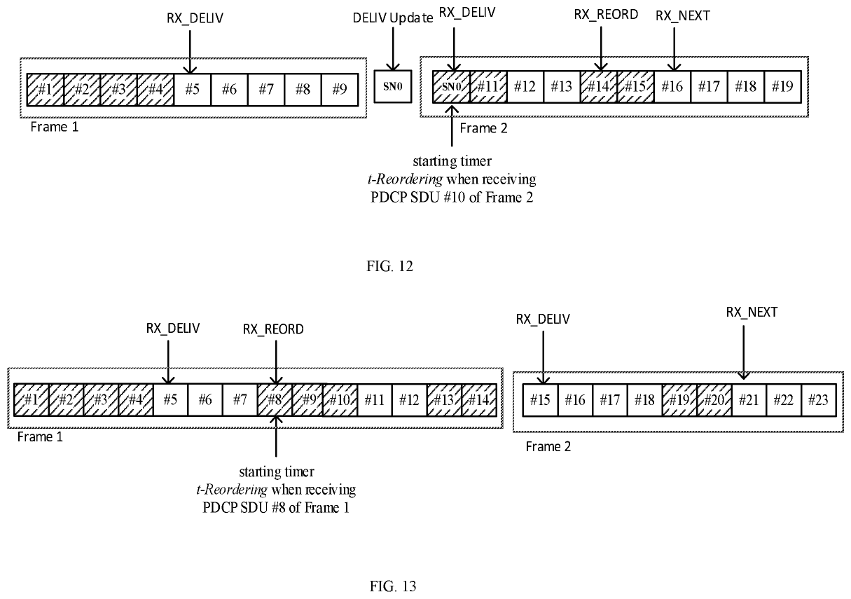

In some embodiments, if the update indication is included in a PDCP control PDU or a MAC sub-PDU, the UE considers a reordering timer of the PDCP entity of the DRB (e.g., timer t-Reordering) as expired, in a case that the reordering timer is running. In some embodiments, in a case that the PDCP control PDU including the update indication includes a PDCP SN or a PDCP count value, the UE determines the target count value based on the PDCP sequence number (SN) or the PDCP count value. Then, the UE may determine a count value of the PDCP control PDU based on the PDCP SN, and determine the count value of the PDCP control PDU as the target count value. A specific example is described in embodiments of FIG. 12 as follows.

In some embodiments, the PDCP SDU not delivered by the PDCP entity of the DRB to the upper layer of the UE belongs to a frame (denoted as “1st frame” for simplicity) (e.g., Frame 1), and the UE receives another PDCP SDU from the network and determines whether this PDCP SDU is a firstly received PDCP SDU of another frame. In an embodiment, in response to determining that this PDCP SDU is the firstly received PDCP SDU of another frame (e.g., Frame 2), the UE delivers all of one or more stored PDCP SDUs of the 1st frame by the PDCP entity of the DRB to the upper layer of the UE. A specific example is described in embodiments of FIG. 13 as follows, in which PDCP SDU #19 of Frame 2 is firstly received by the UE prior to other PDCP SDUs of Frame 2.

In a further embodiment, in response to determining that this PDCP SDU is the firstly received PDCP SDU (e.g., PDCP SDU #19 of Frame 2 as shown in FIG. 8) of another frame (e.g., Frame 2) but is not a start PDCP SDU (e.g., PDCP SDU #15 of Frame 2 as shown in FIG. 8) of the another frame, the UE determines whether a reordering timer of the PDCP entity of the DRB (e.g., timer t-Reordering) is running. In response to determining that the reordering timer is running, the UE may restart the reordering timer or stop the reordering timer. A specific example is described in embodiments of FIG. 8 as follows.

In some embodiments, the UE updates the delivery state variable (e.g., RX_DELIV) to “one plus a maximum count value of a PDCP SDU of the 1st frame (e.g., Frame 1) stored by the UE”. In an embodiment, the UE delivers all of one or more stored PDCP SDUs of the abovementioned another frame (e.g., Frame 2) with one or more consecutive count values starting from the updated delivery state variable by the PDCP entity of the DRB to the upper layer of the UE.

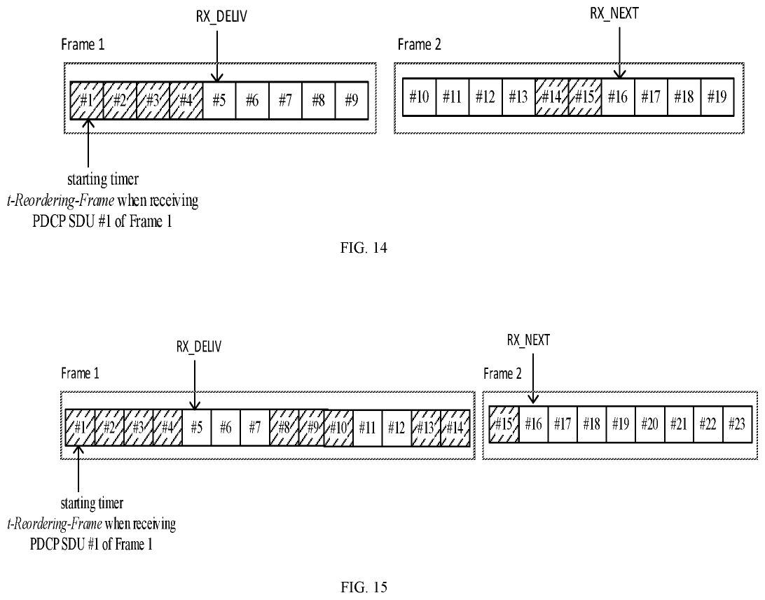

In some embodiments, after the UE receives an additional PDCP SDU from the network, the UE determine whether this PDCP SDU is a firstly received PDCP SDU of a frame (e.g., Frame 1). In response to determining that the PDCP SDU is the firstly received PDCP SDU of the frame, the UE starts a reordering frame timer (e.g., timer t-Reordering-Frame) associated with the frame. In an embodiment, in response to an expiry of the reordering frame timer, the UE delivers all of one or more stored PDCP SDUs of the frame by the PDCP entity of the DRB to the upper layer of the UE. In an embodiment, the UE updates the delivery state variable (e.g., RX_DELIV) to “one plus a maximum count value of a PDCP SDU of the frame stored by the UE”. Specific examples are described in embodiments of FIGS. 14 and 15 as follows.

FIG. 6 illustrates an exemplary flowchart regarding an update function of a delivery state variable in accordance with some embodiments of the subject application. The exemplary method 600 in FIG. 6 may be performed by a network node, e.g., BS. Although described with respect to a BS, it should be understood that other devices may be configured to perform a method similar to that of FIG. 6.

In the exemplary method 600 in FIG. 6, in operation 601, a network node (e.g., BS 101 as shown in FIG. 1) receives a capability supporting an update function of a delivery state variable (e.g., RX_DELIV) associated with a PDCP SDU received by a UE (UE 102 as shown in FIG. 1) from the UE. In operation 602, the network node transmits “a configuration for enabling the update function of the delivery state variable of a PDCP entity of a DRB of the UE” to the UE.

In some embodiments, the network node transmits “an update indication for the delivery state variable of the PDCP entity of the DRB of the UE” to the UE.

In some embodiments, the network node transmits a PDCP SDU of a frame (e.g., Frame 1), and the update indication indicates at least one of: whether a further PDCP SDU belongs to a further frame (e.g., Frame 2 as shown in FIG. 8); or whether the further PDCP SDU is a start PDCP SDU (PDCP SDU #15 of Frame 2 as shown in FIG. 8) of the further frame.

In some embodiments, the update indication indicates at least one of: the UE to consider a count value of the further PDCP SDU as a target count value of the delivery state variable; or the UE to consider a reordering timer of the PDCP entity of the DRB (e.g., timer t-Reordering) as expired in a case that the reordering timer is running.

In some embodiments, the update indication is included in at least one of: a header associated with the further PDCP SDU; a PDCP control PDU; or a MAC sub-PDU.

In an embodiment, the header associated with the further PDCP SDU implicitly indicates the UE to consider a count value of the further PDCP SDU as the target count value. In an embodiment, the header associated with the further PDCP SDU indicates the UE to consider a reordering timer of the PDCP entity of the DRB (e.g., timer t-Reordering) as expired in a case that the reordering timer is running. In an embodiment, the PDCP control PDU includes a PDCP header including a PDU type field which is associated with the update indication. Specific examples are described in embodiments of FIGS. 9, 11A, and 11B as follows.

In an embodiment, the MAC sub-PDU includes a logical channel (LCH) identity (ID) field associated with the update indication. A specific example is described in embodiments of FIG. 10 as follows.

In some embodiments, the network node transmits a configuration related to a reordering frame timer (e.g., timer t-Reordering-Frame) associated with a frame (e.g., Frame 1) to the UE. The reordering frame timer may be used to control the update function of the delivery state variable of the PDCP entity of the DRB related to the frame. Specific examples are described in embodiments of FIGS. 14 and 15 as follows.

It should be appreciated by persons skilled in the art that the sequence of the operations in exemplary procedure 500 or 600 may be changed and that some of the operations in exemplary procedure 500 or 600 may be eliminated or modified, without departing from the spirit and scope of the disclosure. Details described in all other embodiments of the present application are applicable for the embodiments of FIGS. 5 and 6. Moreover, details described in the embodiments of FIGS. 5 and 6 are applicable for all the embodiments of FIGS. 1-4 and 7-17.

In particular, in some embodiments of the subject application, when a BS detects that IP packet(s) of a frame (e.g., Frame 1) to were not successfully transmitted to a UE within the delay budget and determines a PDCP SN gap has happened or will happen upon receiving the next frame (e.g., Frame 2), the BS sends a delivery update indication (DUI) to the UE. The delivery update indication (DUI) may also be named as “a delivery update indicator (DUI)” or “an update indication for a delivery function” or “an update indicator for a delivery function” or the like. For instance, the UE may update RX_DELIV to a count value (or a sum of the count value and an offset value) of a PDCP SDU (e.g., RCVD_COUNT) associated with the DUI upon a reception of the DUI. In the embodiments of the subject application, a frame of a XR service can be replaced by a PDU set, a data burst, or an ADU; and IP packet(s) can be replaced with PDCP SDU(s) or PDCP PDU(s). The offset value may be a positive number or a negative number. The offset value can be configured by the network node or can be a default value, e.g., 1.

FIGS. 7 and 8 illustrate exemplary schematic diagrams for updating a delivery state variable in accordance with some embodiments of the subject application. In embodiments of FIGS. 7 and 8, a UE updates RX_DELIV to a count value of a PDCP SDU (e.g., RCVD_COUNT) associated with the DUI or a UE updates RX_DELIV to a sum of a count value of a PDCP SDU and an offset value (e.g., RCVD_COUNT) upon receiving the DUI from a network node. The offset value may be a positive number or a negative number. The offset value can be configured by the network node or can be a default value, e.g., 1.

In particular, the embodiments of FIG. 7 correspond to the scenario as shown in FIG. 3 with a PDCP SN gap between frames. The embodiments of FIG. 7 include Steps 1-4 as follows.

In Step 1, a BS may transmit a configuration for enabling an update function of a delivery state variable (e.g., RX_DELIV) and/or a non-consecutive data delivery function, e.g., via a RRC message. For example, the BS configures a DELIV information element (IE) of a specific DRB. For instance, the DELIV IE may include at least one of the following two IEs:
(1) DELIV Update IE. For example, value TRUE of this IE in the RRC message indicates that the update function of RX_DELIV is enabled for the DRB. For example, value FALSE of this IE or an absence of this IE in the RRC message indicates that the update function of RX_DELIV is disabled for the DRB.
(2) DELIV Integrity IE. For example, value TRUE of this IE in the RRC message indicates that all the stored consecutive data belonging to a frame or all the stored consecutive data associated with the COUNT value less than or equal to the target COUNT value have been successfully received is delivered to the upper layer if a delivery update indication (DUI) is received; or that all the stored data including consecutive data associated with the COUNT value less than or equal to the RX_REORD is delivered to the upper layer. That's to say, if there's data loss of a frame, any of the stored non-consecutive data belonging to a frame or any of the stored non-consecutive data associated with the COUNT value less than or equal to the target COUNT value is not delivered to the upper layer if a delivery update indication (DUI) is received; or that any of the stored non-consecutive data associated with the COUNT value less than or equal to the RX_REORD is not delivered to the upper layer. All the non-consecutive PDCP SDU(s) less than or equal to the target COUNT (e.g., RX_REORD) is discarded. For example, value FALSE of this IE or an absence of this IE in the RRC message indicates that, when non-consecutive data is received, all the stored non-consecutive data associated with the COUNT value less than or equal to the RX_REORD or the non-consecutive data belonging to a frame is delivered to the upper layer, if the timer t-reordering expires; or that all the stored non-consecutive data associated with the COUNT value less than or equal to the target COUNT value or the non-consecutive data belonging to a frame is delivered to the upper layer if the DUI is received.

In Step 2, the BS detects the DL data transmission failure of PDCP SDU(s) belonging to one frame (e.g., Frame 1 as shown in FIG. 7) based on the hybrid automatic repeat request (HARQ) negative acknowledgement (NACK) information. If the BS determines to update RX_DELIV to a PDCP COUNT value for the UE, the BS determines to send a delivery update indication (DUI) to the UE associated with a target COUNT value.

In an embodiment, the DUI may be presented in the PDCP header associated with a start PDCP SDU of the next frame (e.g., Frame 2 as shown in FIG. 7). For example, the DUI is represented by one bit or two bits. Value “0” of the DUI is reserved. Value “1” of the DUI indicates a COUNT value (or a sum of the COUNT value and an offset value) associated with the PDCP SDU as the target COUNT value to be used to update RX_DELIV for the UE. In general, the COUNT value (or a sum of the COUNT value and an offset value) associated with the PDCP SDU is implicitly indicated as the target COUNT to be used to update the RX_DELIV.

In a further embodiment, the DUI may be a kind of indicator, which indicates whether a PDCP SDU carrying the DUI is a start PDCP SDU of a new frame. For example, one bit value of the DUI is used to indicate whether this PDCP SDU belongs to a new frame, and another bit value of the DUI is used to indicate whether this PDCP SDU is the start PDCP SDU of the new frame.

In Step 3, the BS sets the value of the DUI to “1” in the PDCP header associated with the PDCP SDU, which is associated with the target COUNT value, and sends the PDCP SDU (e.g., PDCP SDU #10 of Frame 2 as shown in FIG. 7) and the associated PDCP header to the UE.

In Step 4, when the UE receives the PDCP SDU and the associated PDCP header, the UE determines the RCVD_COUNT of the PDCP SDU; if the value of the DUI in the associated PDCP header equals to “1”, and if the offset is 0 and the DELIV Integrity IE is disabled (i.e., value FALSE for the DELIV Integrity IE in the RRC message), the UE delivers all the stored non-consecutive PDCP SDU(s) with associated COUNT value(s) less than or equal to RCVD_COUNT, and updates RX_DELIV to a count value of the PDCP SDU (i.e., RCVD_COUNT of PDCP SDU #10 of Frame 2 as shown in FIG. 7). If the offset is 0 and the DELIV Integrity is enabled (i.e., value TRUE for the DELIV Integrity IE in the RRC message), the UE does not deliver any of the stored non-consecutive PDCP SDU(s) with associated COUNT value(s) less than or equal to RCVD_COUNT. That is to say, all the non-consecutive PDCP SDU(s) with associated COUNT value(s) less than or equal to RCVD_COUNT is discarded.

In an embodiment, if the DELIV Update IE is enabled and the DELIV Integrity IE is disabled for the DRB of the UE (i.e., value TRUE for the DELIV Update IE and value FALSE for the DELIV Integrity IE in the RRC message), the UE may perform following operations:

```
  - if RCVD_COUNT > RX_DELIV and DELIV Update IE is enabled
  for the
                DRB and the value of the DUI =1:
  - if the DELIV Integrity IE is disabled for the DRB:
    - deliver to upper layers in ascending order of the associated COUNT
    value
        after performing header decompression, if not decompressed
        before;
        - all stored PDCP SDU(s) with associated COUNT value(s) <
        RX_COUNT;
  - update RX_DELIV to RCVD_COUNT.
- if RCVD_COUNT = RX_DELIV:
  - deliver to upper layers in ascending order of the associated COUNT
  value
      after performing header decompression, if not decompressed
      before;
        - all stored PDCP SDU(s) with consecutively associated
        COUNT
        value(s) starting from COUNT = RX_DELIV;
  - update RX_DELIV to the COUNT value of the first PDCP SDU
  which has
      not been delivered to upper layers, with COUNT value >
      RX_DELIV;
- if t-Reordering is running, and if RX_DELIV >= RX_REORD:
  -stop and reset t-Reordering.
- if t-Reordering is not running (includes the case when t-Reordering is
stopped
    due to actions above), and RX_DELIV < RX_NEXT:
  - update RX_REORD to RX_NEXT;
  - start t-Reordering.
```

Given the above, in the embodiments of FIG. 7, timer t-Reordering is not triggered running by the data loss of the previous Frame 1 (e.g., timer t-Reordering is not started when receiving PDCP SDU #10 of Frame 2), and the delivery delay of Frame 2 caused by Frame 1 is avoided.

Embodiments of FIG. 8 correspond to the scenario as shown in FIG. 4 with several PDCP SN gaps in a frame. The embodiments of FIG. 8 include Steps 1-4. Steps 1-3 in the embodiments of FIG. 8 are the same as Steps 1-3 in the embodiments of FIG. 7. In step 4 of the embodiments of FIG. 8, the UE may receive a PDCP SDU belonging to a new frame (i.e., PDCP SDU #19 of Frame 2) at the first time from the BS (i.e., PDCP SDU #19 is the firstly received PDCP SDU prior to a start PDCP SDU #15 of Frame 2), when timer t-Reordering is running (e.g., timer t-Reordering started when receiving PDCP SDU #8 of Frame 1). For example, timer t-Reordering is started when receiving PDCP SDU #8 of Frame 1, or is started due to receiving PDCP SDU #13 of Frame 1 but not receiving PDCP SDUs #11 and #12 of Frame 1 after the expiry of a previous timer t-Reordering. If the timer t-Reordering is running and the DUI value associated with the firstly received PDCP SDU is “0”, the UE may restart the timer t-Reordering, to guarantee that the timer t-Reordering starts at the suitable timing for the new frame.

In an embodiment, the UE may perform following operations:

```
- if t-Reordering is running, and if RX_DELIV >= RX_REORD:
  -stop and reset t-Reordering.
- if t-Reordering is running, and the PDCP SDU is determined to belong
to a new
    frame and the PDCP SDU is a firstly received PDCP SDU of the
    new frame and
    the associated DUI value equals to 0:
  - restart t-Reordering.
- if t-Reordering is not running (includes the case when t-Reordering is
stopped due
    to actions above), and RX_DELIV < RX_NEXT:
  - update RX_REORD to RX_NEXT;
  - start t-Reordering.
```

In some other embodiments similar to the embodiments of FIG. 8, the DUI is not restricted to a start PDCP SDU of a frame (e.g., Frame 2), and the DUI can be included in any PDCP SDU of the frame. Steps 1-3 in such embodiments are the same as Steps 1-3 in the embodiments of FIG. 8, but Step 4 is different from that of FIG. 8. Specifically, in Step 4, when the UE firstly receives a PDCP SDU of a new frame (i.e., Frame 2) from the BS, if the PDCP SDU is not a start PDCP SDU of the new frame and if timer t-Reordering is running, in an embodiment, the UE restarts the timer t-Reordering, to guarantee the timer t-Reordering starts at the suitable timing for the new frame; and in a further embodiment, the UE may stop the timer t-Reordering.

In an embodiment, the UE may perform following operations:

```
- if t-Reordering is running, the PDCP SDU is the firstly received
PDCP SDU
    belonging to a new frame, but it is not the start PDCP SDU of the
    new frame:
  - restart t-Reordering.
- if t-Reordering is not running (includes the case when t-Reordering is
stopped due
    to actions above), and RX_DELIV < RX_NEXT:
  - update RX_REORD to RX_NEXT;
- start t-Reordering.
```

FIGS. 9-11B illustrate exemplary PDCP control PDU and MAC CE including an updating indication for a delivery state variable in accordance with some embodiments of the subject application. In these embodiments, the DUI may be sent by a BS to a UE separately from a PDCP SDU. In other words, the embodiments of FIGS. 9-11B are the same as the embodiments of FIGS. 7 and 8 in Steps 1 and 2, but different from the embodiments of FIGS. 7 and 8 in Steps 3 and 4. In Steps 3 and 4, the DUI is sent in a PDCP SDU in the embodiments of FIGS. 7 and 8, but is sent separately from a PDCP SDU in the embodiments of FIGS. 9-11B.

In an embodiment, the DUI may be presented in the PDCP header associated with a PDCP SDU in Step 4. For example, the DUI is represented by one bit or two bits. Value “0” of the DUI is reserved. Value “1” of the DUI indicates the PDPC entity of the UE to consider the timer t-Reordering as expired if it is running.

FIG. 9 shows an exemplary PDCP control PDU which carries a DUI. A field of “PDU Type” indicates the type of the PDCP control PDU. The length of the field of “PDU Type” may be 3 bits. That is, a new PDU type in the PDCP control PDU is assigned to identify a delivery update command, e.g., a DELIV update command.

Specifically, in the embodiments of FIG. 9, in Step 3, a BS sends a PDCP control PDU only with a PDCP header to UE. The new PDU type is considered as the DUI. In Step 4, upon receiving the PDCP control PDU from the BS, if timer t-Reordering is running, the PDPC entity of the UE considers the timer t-Reordering as expired. In an embodiment of FIG. 9, the UE may perform following operations:

```
  At reception of a PDCP control PDU including a DELIV Update
  Command, the
receiving PDCP entity shall:
  - if t-Reordering is running, consider the t-Reordering as expired.
```

For instance, in some embodiments, in Step 4, if the DELIV Integrity IE is configured (e.g., in the RRC message), when the RX_REORD is associated with a PDCP PDU (e.g., Frame 1 in FIG. 3), upon the expiry of the timer t-Reordering:
(1) If the DELIV Integrity IE is disabled (i.e., value FALSE for the DELIV Integrity IE in the RRC message), the UE delivers all the stored non-consecutive PDCP SDU(s) associated with the COUNT value less than or equal to the RX_REORD.
(2) If the DELIV Integrity IE is enabled (i.e., value TRUE for the DELIV Integrity IE in the RRC message), the UE may not deliver any of the stored non-consecutive PDCP SDU(s) associated with the COUNT value less than or equal to the RX_REORD. All the non-consecutive PDCP SDU(s) less than or equal to the RX_REORD is discarded.

FIG. 10 shows an exemplary MAC CE along with MAC sub-header which carries the DUI. A field of “LCID” is a logical channel ID field which identifies the type of the DUI in the MAC CE. A field of “DRB ID” indicates the identity of DRB for which timer t-Reordering of the PDCP entity is considered as expired if it is running. The length of the field of “DRB ID” may be 8 bits.

Specifically, in the embodiments of FIG. 10, in Step 3, the DUI can be included in an MAC CE. In Step 4, upon receiving the MAC CE including the DUI from the BS, the MAC entity of the UE indicates the DUI to the PDCP layer of the specific DRB included in the MAC CE. The UE may consider timer t-Reordering corresponding to the specific DRB as expired in a case that the timer t-Reordering is running.

In the split BS-CU and BS-DU case of the embodiments of FIG. 10, BS-CU may send information related to the DUI to BS-DU via NR user plane protocol or NR control plane protocol. The information related to the DUI is used to indicate the DUI of the specific DRB. Then, BS-DU sends the MAC CE including the DUI, which is used to indicate a DELIV update command for the specific DRB.

FIGS. 11A and 11B show exemplary PDCP control PDUs which carry the DUI. As shown in FIG. 11A, the DUI includes the target COUNT value or target PDCP SN in a PDCP control PDU, which may be named as a DELIV update command. The PDU type is the DUI. The UE updates the RX_DELIV based on the target COUNT value or the target PDCP SN.

Specifically, in the embodiments of FIG. 11A, in Step 3, the BS sends a PDCP control PDU including a target COUNT value to the UE. In Step 4, if the target COUNT value is received in the PDCP control PDU from the BS, the UE updates RX_DELIV to the target COUNT value. In an embodiment, as shown in FIG. 11A, the target COUNT value may include 32 bits, e.g., 4 bits in Oct 1, 8 bits in Oct 2, and other 20 bits in other octet(s) (not shown in FIG. 11A). It can be contemplated that a target COUNT value in a PDCP control PDU may contain different total number of bits according to different embodiments without departing from the spirit and scope of the disclosure. In an embodiment of FIG. 11A, the UE may perform following operations:

```
At reception of a PDCP control PDU, the receiving PDCP entity shall:
  - Consider the PDCP COUNT as the RCVD_COUNT.
  - if RCVD_COUNT > RX_DELIV:
```

| | |
|---|---|
| - | deliver to upper layers in ascending order of the associated |
| | COUNT value; |

| - | all stored PDCP SDU(s) with associated COUNT |
|---|---|
| | value(s) < |
| | RCVD_COUNT |
| - | all stored PDCP SDU(s) with consecutively |
| | associated COUNT |
| | value(s) starting from RCVD_COUNT |
| - | update RX_DELIV to the COUNT value of the |
| | first PDCP SDU |

which has not been delivered to upper layers,
with COUNT
value > RCVD_COUNT;

| | |
|---|---|
| - | If RXVD_COUNT > RX_NEXT: |

| | |
|---|---|
| - | update RX_NEXT to RCVD_COUNT + 1. |

| | |
|---|---|
| - | if t-Reordering is running, and if RX_DELIV >= |
| | RX_REORD: |

| | |
|---|---|
| - | stop and reset t-Reordering. |

| - | if RX_DELIV < RX_NEXT: | |
|---|---|---|
| | - | update RX_REORD to RX_NEXT; |
| | - | start t-Reordering. |

In the embodiments of FIG. 11B, in Step 3, the BS sends a PDCP control PDU including a target PDCP SN to the UE. As shown in FIG. 11B, a target PDCP SN may include 12 bits, e.g., 4 bits in Oct 1 and 8 bits in Oct 2. It can be contemplated that a target PDCP SN in a PDCP control PDU may contain different total number of bits according to different embodiments without departing from the spirit and scope of the disclosure. In Step 4, if the target PDCP SN is received in the PDCP control PDU from the BS, the UE updates RX_DELIV based on the target PDCP SN. For example, the UE may determine a count value of the PDCP control PDU based on the target PDCP SN, and determine the count value of the PDCP control PDU as the target COUNT value. Then, the UE may update RX_DELIV to the target COUNT value. A specific example is described in embodiments of FIG. 12 as follows.

In an embodiment of FIG. 11B, the UE may perform following operations: At reception of a PDCP control PDU, the receiving PDCP entity shall:

At reception of a PDCP control PDU, the receiving PDCP entity shall:

| - | RCVD_SN: the PDCP SN of the received PDCP | |
|---|---|---|
| | control PDU, included in the | |
| | PDU header or payload; | |
| - | RCVD_HFN: the HFN associated with the received | |
| | PDCP control PDU, | |
| | calculated by the receiving PDCP entity; | |
| - | RCVD_COUNT: the COUNT associated with the | |
| | received PDCP control | |
| | PDU = [RCVD_HFN, RCVD_SN]. | |
| - | determine the COUNT value associated with the | |
| | received PDCP control PDU, | |
| | i.e. RCVD_COUNT | |
| | - | if RCVD_SN < SN(RX_DELIV) − |
| | | Window_Size: |
| | | - RCVD_HFN = HFN(RX_DELIV) + 1. |
| | - | else if RCVD_SN >= SN(RX_DELIV) + |
| | | Window_Size: |
| | | - RCVD_HFN = HFN(RX_DELIV) − 1. |
| | - | else: |
| | | - RCVD_HFN = HFN(RX_DELIV); |
| | - | RCVD_COUNT = [RCVD_HFN, |
| | | RCVD_SN]. |

- Consider the PDCP COUNT as the RCVD_COUNT...

FIGS. 12 and 13 illustrate exemplary schematic diagrams for updating a delivery state variable in accordance with some embodiments of the subject application.

The embodiments of FIG. 12 correspond to the scenario as shown in FIG. 3 with a PDCP SN gap between frames. In the embodiments of FIG. 12, in Step 1, a BS may transmit a configuration for enabling an update function of a delivery state variable (e.g., RX_DELIV). For example, the BS configures a DELIV IE of a specific DRB. In Step 2, after the BS determines to update RX_DELIV for the UE, the BS determines to send the DUI includes a target PDCP SN in a PDCP control PDU. In Step 3, the BS sends a PDCP control PDU including a target PDCP SN (e.g., SN0 in DELIV Update as shown in FIG. 12) to the UE. In Step 4, the UE determines a count value of the PDCP control PDU based on the target PDCP SN (e.g., SN0), and determines the count value of the PDCP control PDU as the target COUNT value. For example, the UE may determine that the count value of the PDCP control PDU corresponding to SN0 is a count value of PDCP SDU #10 of Frame 2 as shown in FIG. 12. Then, the UE updates RX_DELIV to the target COUNT value, i.e., the count value of PDCP SDU #10.

The embodiments of FIG. 13 correspond to the scenario as shown in FIG. 4 with several PDCP SN gaps in a frame. In the embodiments of FIG. 13, if a PDU SDU of a new frame (e.g., PDCP SDU #19 in Frame 2) arriving at a UE for the first time, the UE may firstly deliver the old frame (e.g., Frame 1) to the upper layer further according to the DELIV Integrity IE if configured, and then may further deliver all the stored PDCP SDUs with consecutively associated COUNT value(s) starting from “1+maximum count value of PDCP SDU(s) of the old frame”. As shown in FIG. 13, the maximum count value of stored PDCP SDU(s) of the old frame is a count value of PDCP SDU #14 in Frame 1. “1+maximum count value of PDCP SDU(s) of the old frame” refers to a count value of PDCP SDU #15 in Frame 2.

For instance, in some embodiments of FIG. 13, in Step 4, if the DELIV Integrity IE is configured (e.g., in the RRC message), when the UE receives the PDCP SDU of the old frame (e.g., Frame 1), if the value of the DUI in the associated PDCP header equals to “1”:
(1) If the offset is 0 and the DELIV Integrity IE is disabled (i.e., value FALSE for the DELIV Integrity IE in the RRC message), the UE delivers all the stored non-consecutive PDCP SDU(s) with associated COUNT value(s) less than RCVD_COUNT of the PDCP SDU of the old frame (e.g., Frame 1), and updates RX_DELIV to “1+maximum count value of PDCP SDU(s) of the old frame” (i.e., RCVD_COUNT of PDCP SDU #15 of Frame 2 as shown in FIG. 13).
(2) If the offset is 0 and the DELIV Integrity is enabled (i.e., value TRUE for the DELIV Integrity IE in the RRC message), the UE does not deliver any of the stored non-consecutive PDCP SDU(s) with associated COUNT value(s) less than RCVD_COUNT of the PDCP SDU of the old frame (e.g., Frame 1). That is to say, all the non-consecutive PDCP SDU(s) with associated COUNT value(s) less than RCVD_COUNT is discarded.

In the embodiments of FIG. 13, the UE firstly updates RX_DELIV to “1+maximum count value of PDCP SDU(s) of the old frame”, and then updates RX_DELIV to “1+maximum count value of PDCP SDU(s)” with consecutively associated COUNT value(s) starting from RX_DELV. As shown in FIG. 13, the UE firstly updates RX_DELIV to “1+count value of PDCP SDU #14 in Frame 1”. The UE may further deliver all the consecutive data with associated COUNT value starting from the RX_DELIV, and may update the COUNT value to the first PDCP SDU which has not been delivered to upper layers with COUNT value>=RX_DELIV.

In the embodiments of FIG. 13, if a PDU SDU of a new frame (e.g., PDCP SDU #19 in Frame 2) arriving at the UE for the first time is not a start PDCP SDU of the new frame and timer t-Reordering is running, the UE may restart timer t-Reordering or may stop timer t-Reordering.

In an embodiment of FIG. 13, the UE may perform following operations:

| - | if RCVD_COUNT > RX_DELIV and the PDCP SDU is the first | |
|---|---|---|
| | received PDCP | |
| | SDU of a new frame: | |
| | - | deliver to upper layers in ascending order of the associated |
| | | COUNT value |

after performing header decompression, if not decompressed
before;

- all stored PDCP SDU(s) associated with old frame
with associated

COUNT value(s) < RX_COUNT;

- all stored PDCP SDU(s) (associated with new frame
and) with

consecutively associated COUNT value(s)
starting from the
1+maximum count value of the PDCP SDU(s)
of old frame;

| - | update RX_DELIV to the 1+COUNT value of the |
|---|---|
| | PDCP SDU(s) |
| | associated with old frame indication with the maximum |
| | count value > |
| | RX_DELV. |
| - | update RX_DELIV to 1+ maximum count value of |
| | the PDCP SDU(s) |

(of the new frame), with consecutively associated
COUNT value(s)
starting from RX_DELV

| - | if t-Reordering is running, and if RX_DELIV >= RX_REORD: | |
|---|---|---|
| | - | stop and reset t-Reordering. |
| - | if t-Reordering is not running (includes the case when t-Reordering | |
| | is stopped | |
| | due to actions above), and RX_DELIV < RX_NEXT: | |
| | - | update RX_REORD to RX_NEXT; |
| | - | start t-Reordering. |

In an embodiment of the subject application, if a PDU SDU of a new frame (e.g., PDCP SDU #19 in Frame 2) arrives at a UE for the first time and timer t-Reordering is running, the UE stops timer t-Reordering and updates RX_DELIV to “1+maximum count value of the old frame”, e.g., “1+count value of PDCP SDU #14 in Frame 1” as shown in FIG. 13.

FIGS. 14 and 15 illustrate exemplary schematic diagrams for a reordering frame timer in accordance with some embodiments of the subject application. In the embodiments of FIGS. 14 and 15, a BS configures a t-Reordering-Frame timer of a specific DRB for a UE. Timer t-Reordering-Frame may also be named as “t-ReorderingFrame” or “Frame t-Reordering” or the like. The timer t-Reordering-Frame may be of a fixed length. This timer is used to replace timer t-Reordering, to manage the data delivery to the upper layer for the UE. Then, the UE starts timer t-Reordering-Frame upon receiving a PDCP SDU of a new frame for the first time. The timer t-Reordering-Frame may be of a fixed length. When the timer t-Reordering-Frame expires, the UE delivers the stored PDCP SDUs of the new frame to upper layers further according to the DELIV Integrity IE if configured, and updates RX_DELIV to at least “1+COUNT value of the PDCP SDU of the new frame which has been received with a maximum count value greater than RX_DELIV”.

For instance, in some embodiments of FIG. 14 or FIG. 15, in Step 4, if the DELIV Integrity IE is configured (e.g., in the RRC message), when the UE receives the PDCP SDU of the new frame (e.g., Frame 2), upon the expiry of the timer t-Reordering-Frame associated with the new frame:
(1) If the DELIV Integrity IE is disabled (i.e., value FALSE for the DELIV Integrity IE in the RRC message), the UE delivers all the stored PDCP SDU(s) belonging to the new frame associated with the timer, and updates RX_DELIV at least to “1+maximum count value of PDCP SDU(s) of the new frame” (i.e., RCVD_COUNT of PDCP SDU #16 of Frame 2 as shown in FIG. 14, or RCVD_COUNT of PDCP SDU #16 of Frame 2 as shown in FIG. 15). The UE may further deliver all the consecutive data with associated COUNT value starting from the RX_DELIV, and may update the COUNT value to the first PDCP SDU which has not been delivered to upper layers with COUNT value>=RX_DELIV.
(2) If the DELIV Integrity is enabled (i.e., value TRUE for the DELIV Integrity IE in the RRC message), the UE may not deliver all the stored non-consecutive PDCP SDU(s) belonging to the new frame associated with the timer, but may update RX_DELIV at least to “1+maximum count value of PDCP SDU(s) of the new frame” (i.e., RCVD_COUNT of PDCP SDU #16 of Frame 2 as shown in FIG. 14, or RCVD_COUNT of PDCP SDU #16 of Frame 2 as shown in FIG. 15). The UE may further deliver all the consecutive data with associated COUNT value starting from the RX_DELIV, and may update the COUNT value to the first PDCP SDU which has not been delivered to upper layers with COUNT value>=RX_DELIV

In some embodiments of FIGS. 14 and 15, the UE may perform following operations:

| | |
|---|---|
| - | if t-Reordering is not configured and t-Reordering-Frame |
| | is not running |

(includes the case when t-Reordering-Frame is stopped), and the
PDCP SDU
is the first received PDCP SDU of a new frame:

- Start t-Reordering-Frame

As shown in FIG. 14, upon receiving a PDCP SDU of Frame 1 for the first time (e.g., PDCP SDU #1 of Frame 1), the UE may start a timer t-Reordering-Frame for Frame 1. When the timer t-Reordering-Frame associated with Frame 1 expires, the UE delivers all stored PDCP SDUs of Frame 1 to upper layers further according to the DELIV Integrity IE if configured (e.g., the same as the embodiments of FIG. 13), and updates RX_DELIV to at least “1+COUNT value of the PDCP SDU #4 of Frame 1 which has been received with a maximum count value greater than RX_DELIV”. Since none of PDCP SDUs #5 to #9 is received or stored by the UE as shown in FIG. 14, the UE does not deliver any PDCP SDU. Moreover, the updated RX_DELIV still equals to a count value of PDCP SDU #5. Similarly, upon receiving a PDCP SDU of Frame 2 for the first time (e.g., PDCP SDU #14 of Frame 2), the UE may start a timer t-Reordering-Frame for Frame 2 (not shown in FIG. 14). When the timer t-Reordering-Frame associated with Frame 2 expires, the UE delivers all stored PDCP SDUs of Frame 2 to upper layers further according to the DELIV Integrity IE if configured, and updates RX_DELIV to at least “1+COUNT value of a PDCP SDU of Frame 2 which has been received with a maximum count value greater than RX_DELIV”.

As shown in FIG. 15, upon receiving PDCP SDU #1 of Frame 1 for the first time, the UE starts a timer t-Reordering-Frame. When the timer t-Reordering-Frame associated with Frame 1 expires, the UE delivers the stored PDCP SDUs of Frame 1 (i.e., PDCP SDUs #8 to #10, #13, and #14 of Frame 1) to upper layers further according to the DELIV Integrity IE if configured (e.g., the same as the embodiments of FIG. 13), and updates RX_DELIV to “1+COUNT value of the PDCP SDU #14 of Frame 1 which has been received with a maximum count value greater than RX_DELIV”. That is, the updated RX_DELIV equals to a count value of PDCP SDU #15 of Frame 2 as shown in FIG. 15. Similarly, upon receiving a PDCP SDU of Frame 2 for the first time (e.g., PDCP SDU #15 of Frame 2), the UE may start a timer t-Reordering-Frame for Frame 2 (not shown in FIG. 15). When the timer t-Reordering-Frame associated with Frame 2 expires, the UE delivers the stored PDCP SDUs of Frame 2 to upper layers further according to the DELIV Integrity IE if configured, and updates RX_DELIV to “1+COUNT value of a PDCP SDU of Frame 2 which has been received with a maximum count value greater than RX_DELIV”.

In some embodiments of FIGS. 14 and 15, the UE may perform following operations:

When t-Reordering-Frame expires, the receiving PDCP entity shall:

| - | if the DELIV Integrity IE is disabled for the DRB: | |
|---|---|---|
| - | deliver to upper layers in ascending order of the associated | |
| | COUNT value | |
| | after performing header decompression, if not decompressed | |
| | before: | |
| | - | all stored PDCP SDU(s) of the frame associated |
| | | with the |
| | | t-Reordering-Frame; |

| | |
|---|---|
| - | update RX_DELIV to the 1+COUNT value of the PDCP |
| | SDU of the frame |
| | associated with the t-Reordering-Frame which has been |
| | received, with the |
| | maximum count value > RX_DELIV; |

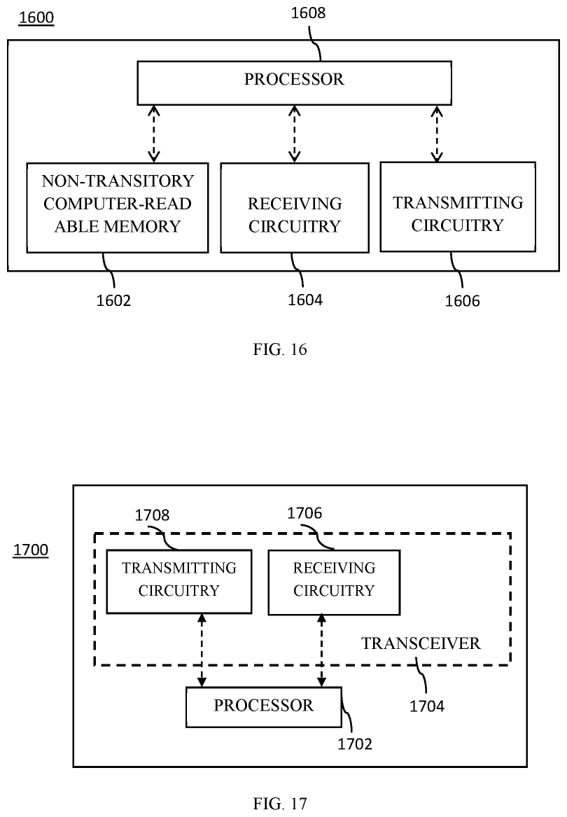

FIG. 16 illustrates an exemplary block diagram of an apparatus 1600 for a data discarding operation in accordance with some embodiments of the subject application. As shown in FIG. 16, the apparatus 1600 may include at least one non-transitory computer-readable medium 1602, at least one receiving circuitry 1604, at least one transmitting circuitry 1606, and at least one processor 1608 coupled to the non-transitory computer-readable medium 1602, the receiving circuitry 1604 and the transmitting circuitry 1606. The at least one processor 1608 may be a CPU, a DSP, a microprocessor etc. The apparatus 1600 may be a network node (e.g., a BS) or a UE configured to perform a method illustrated in the above or the like.

Although in this figure, elements such as the at least one processor 1608, receiving circuitry 1604, and transmitting circuitry 1606 are described in the singular, the plural is contemplated unless a limitation to the singular is explicitly stated. In some embodiments of the subject application, the receiving circuitry 1604 and the transmitting circuitry 1606 can be combined into a single device, such as a transceiver. In certain embodiments of the subject application, the apparatus 1600 may further include an input device, a memory, and/or other components.

In some embodiments of the subject application, the non-transitory computer-readable medium 1602 may have stored thereon computer-executable instructions to cause a processor to implement the methods with respect to a UE or a network node (e.g., a BS) as described or illustrated above. For example, the computer-executable instructions, when executed, cause the processor 1608 interacting with receiving circuitry 1604 and transmitting circuitry 1606, so as to perform the steps with respect to a UE or a network node (e.g., a BS) as described or illustrated above.

FIG. 17 illustrates a further exemplary block diagram of an apparatus 1700 for a data discarding operation in accordance with some embodiments of the subject application. Referring to FIG. 17, the apparatus 1700, for example a BS or a UE, may include at least one processor 1702 and at least one transceiver 1704 coupled to the at least one processor 1702. The transceiver 1704 may include at least one separate receiving circuitry 1706 and transmitting circuitry 1708, or at least one integrated receiving circuitry 1706 and transmitting circuitry 1708. The at least one processor 1702 may be a CPU, a DSP, a microprocessor etc.

According to some embodiments of the subject application, when the apparatus 1700 is a UE, the processor 1702 is configured to: receive a configuration for enabling an update function of a delivery state variable associated with a first packet data convergence protocol (PDCP) service data unit (SDU) not delivered by a PDCP entity of a data radio bearer (DRB) to an upper layer of the UE via the transceiver 1704 from a network; and enable the update function of the delivery state variable for the PDCP entity of the DRB based on the configuration.

According to some other embodiments of the subject application, when the apparatus 1700 is a network node (e.g., a BS), the processor 1702 is configured to receive a capability supporting an update function of a delivery state variable associated with a packet data convergence protocol (PDCP) service data unit (SDU) received by a user equipment (UE) via the transceiver 1704 from the UE; and transmit a configuration for enabling the update function of the delivery state variable of a PDCP entity of a DRB of the UE via the transceiver 1704 to the UE.

According to some embodiments of the subject application, when the apparatus 1700 is a UE, the processor 1702 is configured to: receive a configuration for enabling a non-consecutive packet data convergence protocol (PDCP) service data unit (SDU) delivery function for a PDCP entity of a data radio bearer (DRB) to an upper layer of the UE via the transceiver 1704 from a network; and enable the non-consecutive PDCP SDU delivery function for the PDCP entity of the DRB based on the configuration.

According to some other embodiments of the subject application, when the apparatus 1700 is a network node (e.g., a BS), the processor 1702 is configured to: receive a capability supporting a non-consecutive packet data convergence protocol (PDCP) service data unit (SDU) delivery function associated with a PDCP SDU received by a user equipment (UE) via the transceiver 1704 from the UE; and transmit a configuration for enabling the non-consecutive PDCP SDU delivery function for a PDCP entity of a data radio bearer (DRB) of the UE via the transceiver 1704 to the UE.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A user equipment (UE), comprising:
at least one memory; and
at least one processor coupled with the at least one memory and configured to cause the UE to:
receive an update indication including a target packet data convergence protocol (PDCP) count value in a PDCP control protocol data unit (PDU) from a next generation radio access network (NG-RAN); and
update a next reception state variable to a target count plus one if the target count is larger than the next reception state variable, wherein the next reception state variable indicates a COUNT value of a next PDCP service data unit (SDU) expected to be received.

17. The UE of claim 16, wherein the at least one processor is configured to cause the UE to:
after receiving the update indication, update a delivery state variable to the COUNT value of a first PDCP SDU that has not been delivered to upper layers, wherein the COUNT value is larger than the target count.

18. The UE of claim 17, wherein, before updating the delivery state variable, the at least one processor is configured to cause the UE to:
deliver one or more stored PDCP SDUs with consecutively associated COUNT values to upper layers in an ascending order associated with the associated COUNT values if the target count is larger than a delivery state variable.

19. The UE of claim 18, wherein the at least one processor is configured to cause the UE to:
deliver one or more stored PDCP SDUs with consecutively associated COUNT values to upper layers in ascending order of the associated COUNT value, wherein the associated COUNT value is less than the target count.

20. The UE of claim 17, wherein, after updating the delivery state variable, the at least one processor is configured to cause the UE to:
stop and reset a PDCP reordering timer if the PDCP reordering timer is running and the delivery state variable is greater than or equal to a reordering state variable indicating the COUNT value in response to the COUNT value being associated with the PDCP PDU that triggered the PDCP reordering timer.

21. The UE of claim 16, wherein the at least one processor is configured to cause the UE to:
deliver, to upper layers stored PDCP SDUs having one or more consecutively associated COUNT values starting from the target count in an ascending order of the associated COUNT values.

22. The UE of claim 17, wherein the at least one processor is configured to cause the UE to:
if a delivery state variable is less than a next reception state variable, update a reordering state variable to the next reception state variable,
start a PDCP reordering timer.

23. A processor for wireless communication, comprising:
at least one controller coupled with at least one memory and configured to cause the processor to:
receive an update indication including a target packet data convergence protocol (PDCP) count value in a PDCP control protocol data unit (PDU) from a next generation radio access network (NG-RAN); and
update a next reception state variable to a target count plus one if the target count is larger than the next reception state variable, wherein the next reception state variable indicates a COUNT value of a next PDCP service data unit (SDU) expected to be received.

24. The processor of claim 23, wherein the at least one controller is configured to cause the processor to:
after receiving the update indication, update a delivery state variable to the COUNT value of a first PDCP SDU that has not been delivered to upper layers, wherein the COUNT value is larger than the target count.

25. The processor of claim 24, wherein, before updating the delivery state variable, the at least one controller is configured to cause the processor to:
deliver one or more stored PDCP SDUs with consecutively associated COUNT values to upper layers in an ascending order associated with the associated COUNT values if the target count is larger than a delivery state variable.

26. The processor of claim 25, wherein the at least one controller is configured to cause the processor to:
deliver one or more stored PDCP SDUs with consecutively associated COUNT values to upper layers in ascending order of the associated COUNT value, wherein the associated COUNT value is less than the target count.

27. The processor of claim 24, wherein, after updating the delivery state variable, the at least one controller is configured to cause the processor to:
stop and reset a PDCP reordering timer if the PDCP reordering timer is running and the delivery state variable is greater than or equal to a reordering state variable indicating the COUNT value in response to the COUNT value being associated with the PDCP PDU that triggered the PDCP reordering timer.

28. The processor of claim 23, wherein the at least one controller is configured to cause the processor to:
deliver, to upper layers stored PDCP SDUs having one or more consecutively associated COUNT values starting from the target count in an ascending order of the associated COUNT values.

29. The processor of claim 24, wherein the at least one controller is configured to cause the processor to:
if a delivery state variable is less than a next reception state variable, update a reordering state variable to the next reception state variable,
start a PDCP reordering timer.

30. A method performed by a user equipment (UE), the method comprising:
receiving an update indication including a target packet data convergence protocol (PDCP) count value in a PDCP control protocol data unit (PDU) from a next generation radio access network (NG-RAN); and
updating a next reception state variable to a target count plus one if the target count is larger than the next reception state variable, wherein the next reception state variable indicates a COUNT value of a next PDCP service data unit (SDU) expected to be received.

31. The method of claim 30, further comprising:
after receiving the update indication, updating a delivery state variable to the COUNT value of a first PDCP SDU that has not been delivered to upper layers, wherein the COUNT value is larger than the target count.

32. The method of claim 31, further comprising, before updating the delivery state variable:
delivering one or more stored PDCP SDUs with consecutively associated COUNT values to upper layers in an ascending order associated with the associated COUNT values if the target count is larger than a delivery state variable.

33. The method of claim 32, further comprising:
delivering one or more stored PDCP SDUs with consecutively associated COUNT values to upper layers in ascending order of the associated COUNT value, wherein the associated COUNT value is less than the target count.

34. A network node, comprising:
at least one memory; and
at least one processor coupled with the at least one memory and configured to cause the network node to:
in response to detecting that internet protocol (IP) packets are not successfully transmitted to a user equipment (UE) within a delay budget and determining occurrence of a packet data convergence protocol (PDCP) sequence number (SN) gap, transmit, to UE, an update indication including a target PDCP count value in a PDCP control protocol data unit (PDU).

35. The network node of claim 34, wherein the at least one processor is configured to cause the network node to:
receive capability information indicating support for an update function of a delivery state variable associated with a PDCP service data unit (SDU) received by the UE.
